(19) United States
(12) Patent Application Publication
(10) Pub. No.: US 2011/0286242 A1
(43) Pub. Date: Nov. 24, 2011

(54) LIGHT GUIDE PANEL, FRONT-LIGHT MODULE AND REFLECTIVE DISPLAY APPARATUS

(75) Inventors: Chan-Chang Ni, Taoyuan (TW); Hao-Chien Chang, Taoyuan (TW); Guo-Chen Lee, Taoyuan (TW)

(73) Assignee: GLOBAL LIGHTING TECHNOLOGIES INC., Taoyuan (TW)

(21) Appl. No.: 13/090,257

(22) Filed: Apr. 20, 2011

(30) Foreign Application Priority Data
May 18, 2010 (TW) 99115784

(51) Int. Cl. F21V 8/00

(52) U.S. Cl. 362/622

(57) ABSTRACT

A light guide panel (LGP) has a light incident surface for receiving light. The LGP is configured at a side of a display surface of a reflective display panel. Besides, the LGP includes a main body, a first film, and a plurality of circular light guide patterns. The first film is configured on one side surface of the main body away from the display surface. The circular light guide patterns are configured on the first film, so that the light transmitted in the LGP exits and substantially moves toward the display surface. Each of the circular light guide patterns has a center and a circumference. An included angle is between two lines that respectively connect the center to the circumference located at two sides of the center, and the included angle is 140°˜179°.

### CROSS-REFERENCE TO RELATED APPLICATION

This application claims the priority benefit of Taiwan application serial no. 99115784, filed on May 18, 2010. The entirety of the above-mentioned patent application is hereby incorporated by reference herein and made a part of this specification.

### BACKGROUND OF THE INVENTION

1. Field of the Invention

The invention relates to a light guide panel (LGP), a front-light module, and a reflective display apparatus. More particularly, the invention relates to an LGP and a front-light module that are configured in front of a reflective display panel, such that the reflective display panel can display images clearly.

2. Description of Related Art

Following the vigorous development of digital media and display technology, flat panel displays (FPDs) have become the main interface between human beings and digital information. Owing to the prosperous evolution of e-books, users are apt to access different digital contents that can be demonstrated by the e-books on the same digital platform, and thus the e-books gradually replace the conventional paperbacks or hardbacks.

At present, one of the mainstream e-books is a reflective e-book that can be easily read when a natural light source is given. However, the reflective e-book that demonstrates the digital information based on the reflective display principle is rather dependent on the intensity of the external light source. Since the reflective effects achieved by the reflective e-book are subject to the intensity of the external light source, the reflective e-book cannot display images clearly as long as the external light is overly dim.

Accordingly, a display technique for displaying images clearly on the e-book without being subject to the intensity of the external light source is in need.

### SUMMARY OF THE INVENTION

The invention is directed to an LGP that can be configured in front of a display surface of a reflective display panel, so as to supply a planar light source that emits light to the reflective display panel and allows the reflective display panel to display images clearly.

The invention is further directed to a front-light module having the aforesaid LGP for supplying a sufficient planar light source that allows a reflective display panel to display images clearly.

The invention is further directed to a reflective display apparatus having the aforesaid front-light module for displaying images clearly.

In an embodiment of the invention, an LGP having a light incident surface for receiving light is provided. The LGP is configured at a side of a display surface of a reflective display panel. Besides, the LGP includes a main body, a first film, and a plurality of circular light guide patterns. The first film is configured on one side surface of the main body away from the display surface. The circular light guide patterns are configured on the first film, such that the light transmitted in the LGP exits and substantially moves toward the display surface. Each of the circular light guide patterns has a center and a circumference. An included angle is between two lines that respectively connect the center to the circumference located at two sides of the center, and the included angle is 140°˜179°.

According to an embodiment of the invention, the circular light guide patterns are circular cavities or circular protrusions.

According to an embodiment of the invention, the LGP further includes a second film. The second film is configured on the other side surface of the main body facing the display surface.

According to an embodiment of the invention, the first film and the second film are hard coating layers.

According to an embodiment of the invention, a material of the main body is a single optical material or a composite optical material.

In an embodiment of the invention, an LGP having a light incident surface for receiving light is provided. The LGP is configured at a side of a display surface of a reflective display panel. The LGP includes a main body, a first film, and a plurality of circular light guide patterns. The first film is configured on one side surface of the main body facing the display surface. The circular light guide patterns are configured on the first film, such that the light transmitted in the LGP exits and substantially moves toward the display surface. Each of the circular light guide patterns has a height and a diameter, and a ratio of the height to the diameter is 0.4˜0.9.

According to an embodiment of the invention, the circular light guide patterns are circular cavities or circular protrusions.

According to an embodiment of the invention, the LGP further includes a second film. The second film is configured on the other side surface of the main body away from the display surface.

According to an embodiment of the invention, the first film and the second film are hard coating layers.

According to an embodiment of the invention, a material of the main body is a single optical material or a composite optical material.

In an embodiment of the invention, a front-light module that includes the aforesaid LGP and a light source is provided. The light source is configured next to the light incident surface of the LGP.

In an embodiment of the invention, a reflective display apparatus that includes the aforesaid front-light module and a reflective display panel is provided. The front-light module is configured at a side of a display surface of the reflective display panel.

Based on the above, the front-light module described in the embodiments of the invention is configured in front of the reflective display panel, so as to illuminate the reflective display panel. Thereby, the display effects achieved by the reflective display panel are not subject to the intensity of the external light source. In particular, the front-light module is equipped with the LGP which has the special circular light guide patterns, such that the light emitted in a downward manner and the light emitted in an upward manner can be adjusted in a proper proportion. As a result, the reflective display panel can display images clearly.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a partial top view illustrating an LGP according to a first embodiment of the invention.

FIG. 2 is a schematic cross-sectional view taken along a line A-A′ depicted in FIG. 1.

FIG. 3 includes a schematic view illustrating light moving in the LGP and a schematic enlarged view of circular light guide patterns.

FIG. 4 is a schematic cross-sectional view illustrating an LGP according to a second embodiment of the invention.

FIG. 5 is a partial bottom view illustrating an LGP according to a third embodiment of the invention.

FIG. 6 is a schematic cross-sectional view taken along a line B-B′ depicted in FIG. 5.

FIG. 7 includes a schematic view illustrating light moving in the LGP and a schematic enlarged view of circular light guide patterns.

FIG. 8 is a schematic cross-sectional view illustrating an LGP according to a fourth embodiment of the invention.

### DESCRIPTION OF EMBODIMENTS

In the invention, a front-light module is configured in front of a display surface of a reflective display panel for illuminating the reflective display panel, and thereby display effects accomplished by the reflective display panel are not subject to the intensity of an external light source. In particular, the front-light module is equipped with the LGP which has the special circular light guide patterns, such that light emitted in a downward manner and light emitted in an upward manner can be adjusted in a proper proportion. As a result, the reflective display panel can display images clearly.

The LGP, the front-light module, and the reflective display apparatus are described in the following embodiments of the invention, while the descriptions are exemplary and should not be construed as limitations to the invention.

[LGP]

### First Embodiment

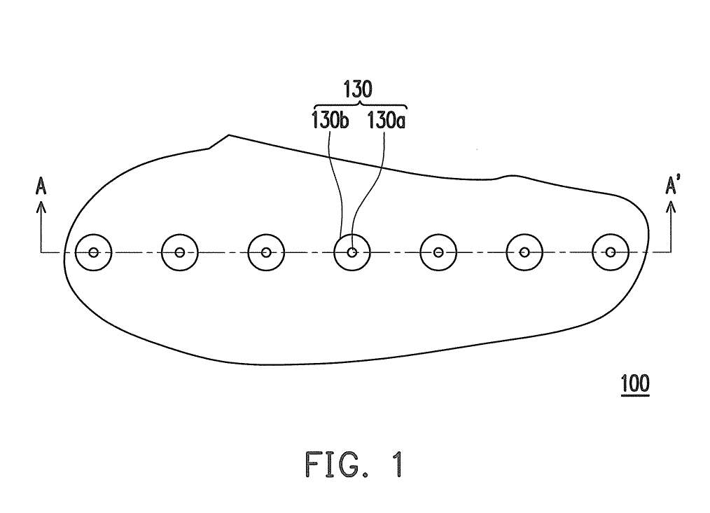

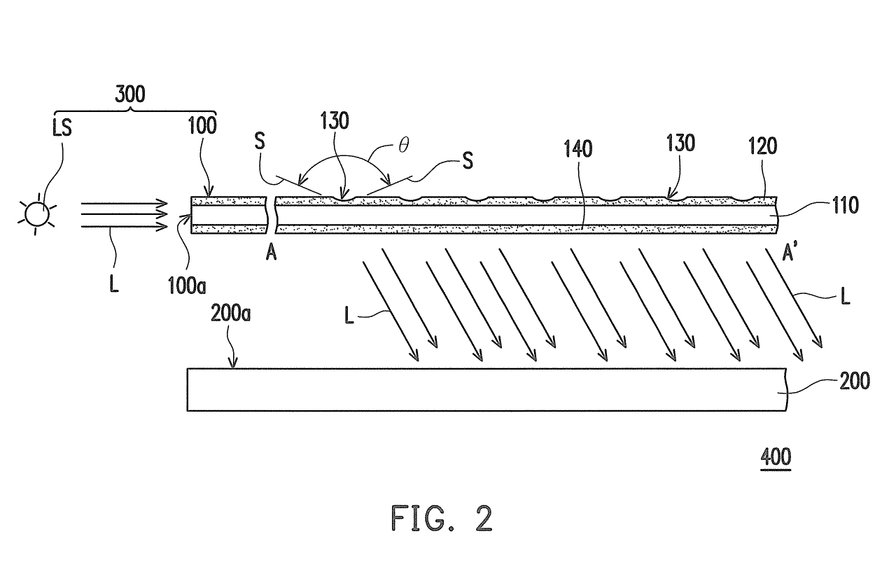

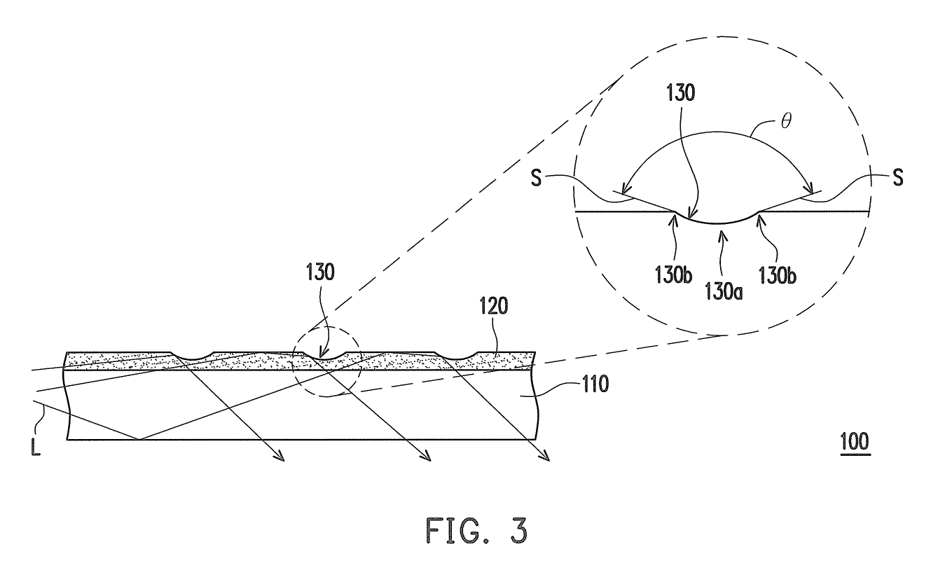

FIG. 1 is a partial top view illustrating an LGP according to a first embodiment of the invention. FIG. 2 is a schematic cross-sectional view taken along a line A-A′ depicted in FIG. 1. FIG. 3 includes a schematic view illustrating light moving in the LGP and a schematic enlarged view of circular light guide patterns.

With reference to FIG. 1 and FIG. 2, the LGP 100 has a light incident surface 100a for receiving light L. Here, the LGP 100 is configured at a side of a display surface 200a of a reflective display panel 200. The LGP 100 includes a main body 110, a first film 120, and a plurality of circular light guide patterns 130. The first film 120 is configured on one side surface of the main body 110 away from the display surface 200a. The circular light guide patterns 130 are configured on the first film 120, such that the light L transmitted in the LGP 100 exits and substantially moves toward the display surface 200a. Each of the circular light guide patterns 130 has a center 130a and a circumference 130b. An included angle θ is between two lines S that respectively connect the center 130a to the circumference 130b located at two sides of the center 130a, and the included angle θ is 140°˜179°.

With reference to FIG. 2, in the first embodiment, the circular light guide patterns 130 are circular cavities. Namely, when the circular light guide patterns 130 with specific angles are configured on one side surface (the top surface) of the LGP 100 away from the display surface 200a, most of the light L can be emitted in a downward manner and then be provided to the reflective display panel 200.

FIG. 3 shows how the light L moving in the LGP 100 is reflected or refracted by the circular light guide patterns 130 and how the angles of the circular light guide patterns 130 are defined. Generally, when the light L moving in the LGP 100 encounters the circular light guide patterns 130, the light L is reflected by the interface of the circular light guide patterns 130 and is then emitted in a downward manner (as shown in FIG. 3), or the light L is refracted and emitted in an upward manner.

The angles of the circular light guide patterns 130 are defined as the included angle θ between two lines S passing through the center 130a and the circumference 130b. When the included angle θ of the circular light guide patterns 130 is determined to range from 140° to 179° , most of the light L (approximately 60% or more) is reflected by the circular light guide patterns 130 and emitted in a downward manner, and the rest of the light L (approximately 40% or less) is refracted and emitted in an upward manner.

Based on the above, when the display surface 200a of the reflective display panel 200 is observed from the top of the LGP 100, at most 40% of the light L is emitted in an upward manner, and thus image definition is not affected. By contrast, given the included angle θ of the circular light guide patterns 130 is less than 140°, more than 40% of the light L is emitted in an upward manner, which leads to reduction of image definition.

In FIG, 2, the LGP 100 can further include a second film 140 configured on the other side surface of the main body 110 facing the display surface 200a. The first film 120 and the second film 140 can be hard coating layers, so as to prevent the main body 110 of the LGP 100 from being directly damaged by external forces. A material of the main body 110 can be a single optical material (e.g., an acrylic material) or a composite optical material including a combination of optical materials, for instance, a combination of the acrylic material and polymethylmethacrylate (PMMA). Undoubtedly, people having ordinary skill in the art can use other appropriate optical materials to make the main body 110. The optical materials include but are not limited to the acrylic material or PMMA.

Further, the circular light guide patterns 130 can also avoid glare, guard against fingerprints, and prevent the LGP 100 from dirt when the light source is not on and the light L has not yet entered the LGP 100.

To sum up, in the LGP 100 of the first embodiment, at least 60% of the light L can be emitted in a downward manner (along a direction toward the reflective display panel 200), and at most 40% of the light L can be emitted in an upward manner. Thereby, the reflective display panel 200 can display images clearly without being subject to the intensity of the external light source.

### Second Embodiment

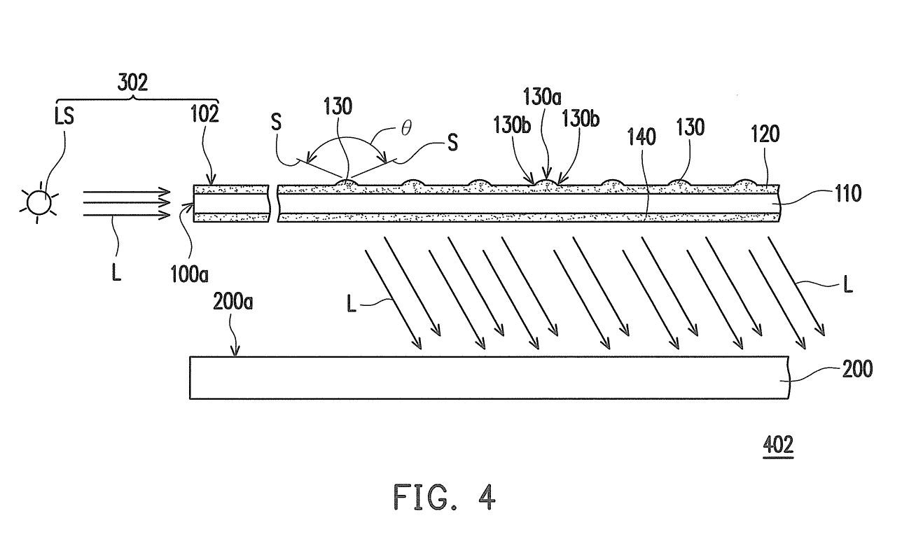

FIG. 4 is a schematic cross-sectional view illustrating an LGP according to a second embodiment of the invention. With reference to FIG. 4, the LGP 102 of this embodiment is similar to the LGP 100 described in the first embodiment, and the same elements in these two embodiments are marked by the same reference numbers. Note that the difference between these two embodiments lies in that the circular light guide patterns 130 shown in FIG. 4 are circular protrusions.

Likewise, in this embodiment, each of the circular light guide patterns 130 (e.g., each of the circular protrusions) has a center 130a and a circumference 130b. An included angle θ is between two lines S that respectively connect the center 130a to the circumference 130b located at two sides of the center 130a, and the included angle θ is 140°˜179°. Functions and relevant explanations of elements in the LGP 102 are substantially the same as those in the LGP 100 of the first embodiment, and therefore no further description is provided herein. The functions achieved by the LGP 100 can be substantially achieved by the LGP 102 as well.

### Third Embodiment

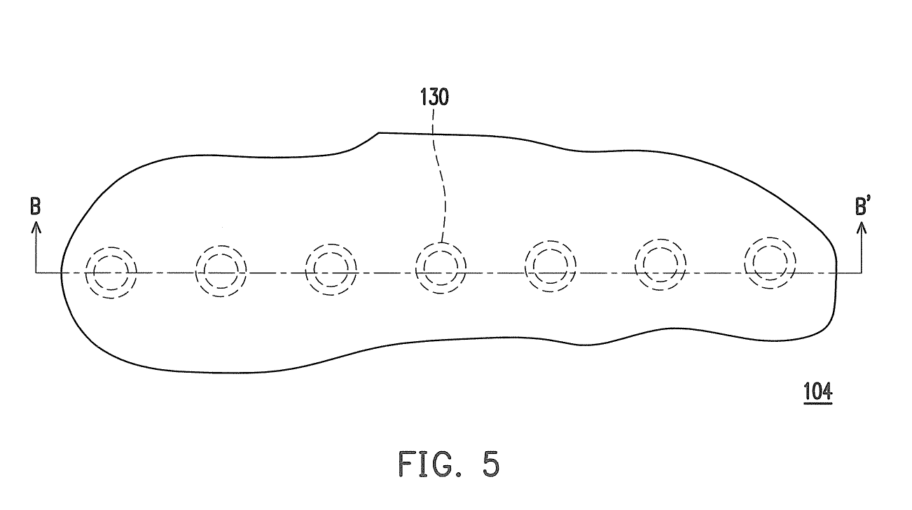

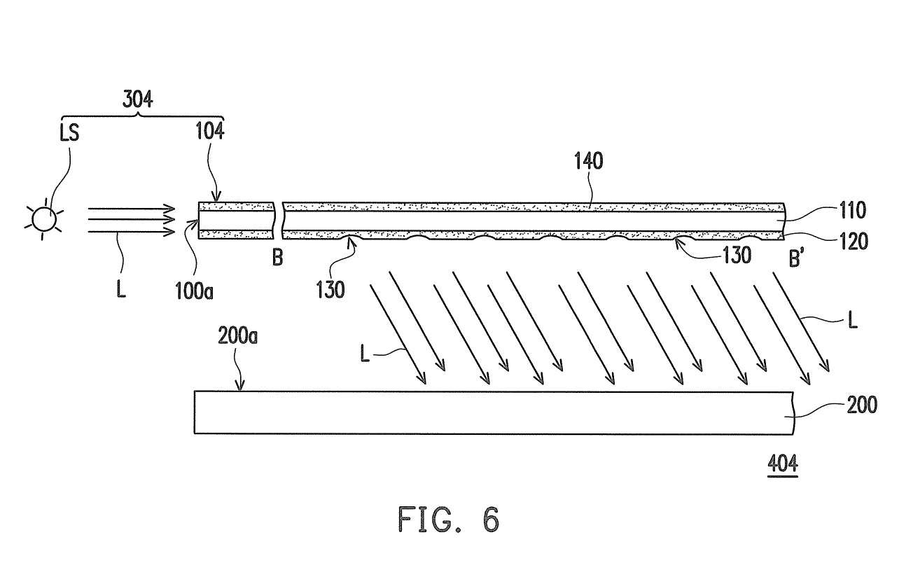

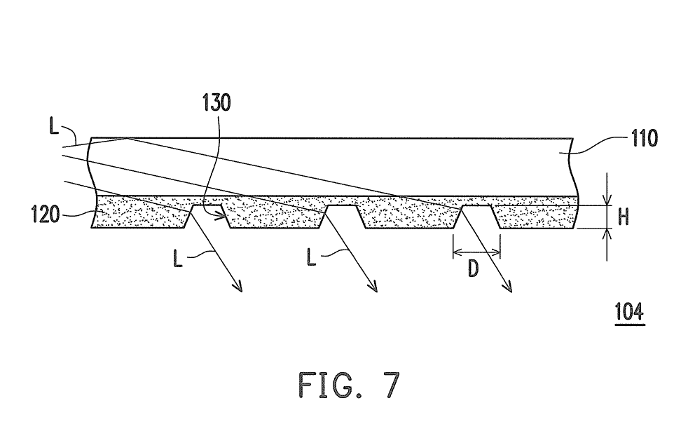

FIG. 5 is a partial bottom view illustrating an LGP according to a third embodiment of the invention. FIG. 6 is a schematic cross-sectional view taken along a line B-B′ depicted in FIG. 5. FIG. 7 includes a schematic view illustrating light moving in the LGP and a schematic enlarged view of circular light guide patterns.

With reference to FIG. 5 and FIG. 6, the LGP 104 has a light incident surface 100a for receiving light L. Here, the LGP 104 is configured at a side of a display surface 200a of a reflective display panel 200. The LGP 104 includes a main body 110, a first film 120, and a plurality of circular light guide patterns 130. The first film 120 is configured on one side surface of the main body 110 facing the display surface 200a. The circular light guide patterns 130 are configured on the first film 120, such that the light L transmitted in the LGP 104 exits and substantially moves toward the display surface 200a. Each of the circular light guide patterns 130 has a height H and a diameter D, and a ratio of the height H to the diameter D is 0.4˜0.9.

With reference to FIG. 6, in the third embodiment, the circular light guide patterns 130 are circular cavities. Namely, when the circular light guide patterns 130 with the specific height-to-diameter (H-D) ratio are configured on one side surface (the bottom surface) of the LGP 104 facing the display surface 200a, most of the light L can be emitted in a downward manner and be provided to the reflective display panel 200.

FIG. 7 shows how the light L moving in the LGP 104 is reflected or refracted by the circular light guide patterns 130 and how the H-D ratio of the circular light guide patterns 130 is calculated. Generally, when the light L moving in the LGP 104 encounters the circular light guide patterns 130, the light L is refracted by the interface of the circular light guide patterns 130 and is then emitted in a downward manner (as shown in FIG. 7), or the light L is reflected and emitted in an upward manner.

As indicated in FIG. 7, when the ratio of the height H to the diameter D of each of the circular light guide patterns 130 is determined to be 0.4˜0.9, most of the light L (approximately 60% or more) is refracted by the circular light guide patterns 130 and emitted in a downward manner, and the rest of the light L (approximately 40% or less) is reflected and emitted in an upward manner.

Based on the above, when the display surface 200a of the reflective display panel 200 is observed from the top of the LGP 104, at most 40% of the light L is emitted in an upward manner, and thus image definition is not affected. By contrast, given the ratio of the height H to the diameter D is less than 0.4, more than 40% of the light L is emitted in an upward manner, which leads to reduction of image definition.

In FIG. 6, the LGP 104 can further include a second film 140 configured on the other side surface of the main body 110 away from the display surface 200a. The first film 120 and the second film 140 can be hard coating layers, so as to prevent the main body 110 of the LGP 104 from being directly damaged by external stress. A material of the main body 110 can be a single optical material (e.g., an acrylic material) or a composite optical material including a combination of optical materials, for instance, a combination of the acrylic material and PMMA. Undoubtedly, people having ordinary skill in the art can use other appropriate optical materials to make the main body 110. The optical materials include but are not limited to the acrylic material or PMMA.

To sum up, in the LGP 104 of the third embodiment, at least 60% of the light L can be emitted in a downward manner (along a direction toward the reflective display panel 200), and at most 40% of the light L can be emitted in an upward manner. Thereby, the reflective display panel 200 can display images clearly without being subject to the intensity of the external light source.

### Fourth Embodiment

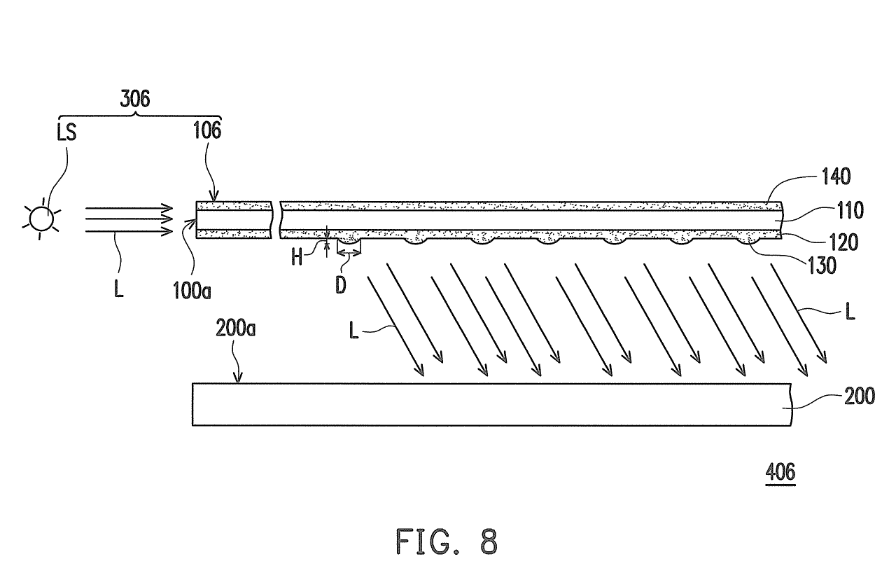

FIG. 8 is a schematic cross-sectional view illustrating an LGP according to a fourth embodiment of the invention. With reference to FIG. 8, the LGP 106 of this embodiment is similar to the LGP 104 described in the third embodiment, and the same elements in these two embodiments are marked by the same reference numbers. Note that the difference between these two embodiments lies in that the circular light guide patterns 130 shown in FIG. 8 are circular protrusions.

Likewise, in this embodiment, each of the circular light guide patterns 130 (e.g., each of the circular protrusions) has a height and a diameter D, and a ratio of the height H to the diameter D is 0.4˜0.9.

Functions and relevant explanations of elements in the LGP 106 are substantially the same as those in the LGP 104 of the third embodiment, and therefore no further description is provided herein. The functions achieved by the LGP 104 can be substantially achieved by the LGP 106 as well.

[Front-Light Module and Reflective Display Apparatus]

With reference to any of FIG. 2, FIG. 4, FIG. 6, and FIG. 8, the LGP 100, 102, 104, or 106 described in the embodiments of the invention can be applied to any of the front-light modules 300, 302, 304, and 306. Specifically, the front-light module 300, 302, 304, or 306 respectively includes a light source LS and the LGP 100, 102, 104, or 106. The light source LS is configured next to the light incident surface 100a of the LGP 100, 102, 104, or 106.

The front-light module 300, 302, 304, or 306 can be configured in front of the display surface 200a of the reflective display panel 200 through the special circular light guide patterns 130, while the image definition is not affected by the front-light module 300, 302, 304, or 306. Besides, the issue of poor image display on the conventional reflective display panel 200 dependent on the external light source can be resolved by configuring the front-light module 300, 302, 304, or 306.

Further, with reference to any of FIG. 2, FIG. 4, FIG. 6, and FIG. 8, the front-light module 300, 302, 304, or 306 described in the embodiments of the invention can be applied to any of the reflective display apparatuses 400, 402, 404, and 406. Specifically, the reflective display apparatus 400, 402, 404, or 406 respectively includes the reflective display panel 200 and the front-light module 300, 302, 304, or 306. The front-light module 300, 302, 304, or 306 is configured at a side of the display surface 200a of the reflective display panel 200.

Since the LGP 100, 102, 104, or 106 described in this invention has the special circular light guide patterns 130, at least 60% of the light L can move toward the reflective display panel 200 (below the LGP 100, 102, 104, or 106), and at most 40% of the light L can move toward the top of the LGP 100, 102, 104, or 106. Hence, even though the LGP 100, 102, 104, or 106 is configured in front of the display surface 200a of the reflective display panel 200, the reflective display apparatus 400, 402, 404, or 406 can display images clearly.

Owing to the vigorous development of the e-books, the front-light module 300, 302, 304, or 306 having the LGP 100, 102, 104, or 106 described in the embodiments of the invention allows flexible use of the e-books.

In light of the foregoing, the LGP, the front-light module, and the reflective display apparatus described in the embodiments of the invention at least have following advantages.

Since the front-light module is configured in front of the display surface of the reflective display panel, the display effects achieved by the reflective display panel are not subject to the intensity of the external light source. In particular, the front-light module is equipped with the LGP which has the special circular light guide patterns, such that the light emitted in a downward manner and the light emitted in an upward manner can be adjusted in a proper proportion. As a result, the reflective display panel can display images clearly. Moreover, the circular light guide patterns can avoid glare, guard against fingerprints, and prevent the LGP from dirt.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A light guide panel having a light incident surface for receiving light, the light guide panel being configured at a side of a display surface of a reflective display panel and comprising:
a main body;
a first film configured on one side surface of the main body away from the display surface; and
a plurality of circular light guide patterns configured on the first film, such that the light transmitted in the light guide panel exits and substantially moves toward the display surface,
each of the circular light guide patterns having a center and a circumference, wherein an included angle is between two lines that respectively connect the center to the circumference located at two sides of the center, and the included angle is 140°˜179° .

2. The light guide panel as claimed in claim 1, wherein the circular light guide patterns are circular cavities or circular protrusions.

3. The light guide panel as claimed in claim 1, further comprising:
a second film configured on the other side surface of the main body facing the display surface.

4. The light guide panel as claimed in claim 3, wherein the first film and the second film are hard coating layers.

5. The light guide panel as claimed in claim 1, wherein a material of the main body is a single optical material or a composite optical material.

6. A light guide panel having a light incident surface for receiving light, the light guide panel being configured at a side of a display surface of a reflective display panel and comprising:
a main body;
a first film configured on one side surface of the main body facing the display surface; and
a plurality of circular light guide patterns configured on the first film, such that the light transmitted in the light guide panel exits and substantially moves toward the display surface,
each of the circular light guide patterns having a height and a diameter, wherein a ratio of the height to the diameter is 0.4˜0.9.

7. The light guide panel as claimed in claim 6, wherein the circular light guide patterns are circular cavities or circular protrusions.

8. The light guide panel as claimed in claim 6, further comprising:
a second film configured on the other side surface of the main body away from the display surface.

9. The light guide panel as claimed in claim 8, wherein the first film and the second film are hard coating layers.

10. The light guide panel as claimed in claim 6, wherein a material of the main body is a single optical material or a composite optical material.
